(19) United States
(12) Patent Application Publication
(10) Pub. No.: US 2026/0092859 A1
(43) Pub. Date: Apr. 2, 2026

(54) REALTIME NORMALIZATION OF FLOW CYTOMETRY DATA

(71) Applicant: UNIVERSITY OF UTAH RESEARCH FOUNDATION, Salt Lake City, UT (US)

(72) Inventors: David P. Ng, Salt Lake City, UT (US); Lauren Zuromski, Salt Lake City, UT (US); Keith Simmon, Salt Lake City, UT (US); Jacob Durtschi, Salt Lake City, UT (US)

(21) Appl. No.: 19/347,207

(22) Filed: Oct. 1, 2025

Related U.S. Application Data
(60) Provisional application No. 63/702,524, filed on Oct. 2, 2024.
(60) Provisional application No. 63/702,501, filed on Oct. 2, 2024.

(51) Int. Cl. G01N 15/1429; G01N 15/01; G01N 15/10

(52) U.S. Cl. CPC G01N 15/1429; G01N 15/01; G01N 2015/1006

(57) ABSTRACT

Systems, methods, and apparatuses for performing real-time data analytics. One apparatus includes at least one electronic processor and at least one memory storing instructions executable by the at least one electronic processor. The at least one electronic processor is configured to obtain a sequence of cytometry data output by a cytometry instrument, normalize a first data point in the sequence of cytometry data using a set of normalization parameters determined based on a queue of cases belonging to a predetermined class, update the queue of cases belonging to the predetermined class with the normalized first data point in response to determining, using a machine learning model, the normalized first data point belongs to the predetermined class, and normalize a second data point in the sequence of cytometry data using an updated set of normalization parameters determined based on the updated queue of cases belonging to the predetermined class.

### RELATED APPLICATIONS

This application claims priority to U.S. Provisional Application Nos. 63/702,524 and 63/702,501, both filed Oct. 2, 2024, the entire content of each is incorporated by reference herein.

### FIELD

Examples described herein generally relate to flow cytometry and, in particular, processing flow cytometry data.

### SUMMARY

Flow cytometry is a technique used in biology, immunology, and medical diagnostics to analyze physical and chemical characteristics of individual cells or particles as the cells or particles flow in a fluid stream through a beam of light. Flow cytometry allows for the rapid and simultaneous measurement of multiple parameters for the cells within a heterogeneous population, providing detailed information for diagnosing various blood disorders and immune system abnormalities.

Some flow cytometry analysis methods rely on expert interpretation of complex multidimensional data. These methods can be time-consuming and subject to variability in interpretation across different observers. Automated flow cytometry analysis methods also face challenges. For example, the high dimensionality and variability of flow cytometry data make it difficult to develop robust, generalizable algorithms for these automated methods. In addition, instrument drift and variations between different cytometers can lead to inconsistencies in measurements over time and across different laboratories. Some automated analysis methods struggle to adapt to the gradual changes in instrument performance and sample characteristics that occur in real-world clinical settings.

Normalization methods in data analysis are techniques used to adjust values measured on different scales to the same scale, facilitating meaningful comparisons and reducing the impact of outliners. Normalization of flow cytometry data can be meaningful for machine learning tasks in flow cytometry analysis, as normalization helps to standardize measurements across different instruments, time points, and experimental conditions, thereby improving the accuracy and reliability of automated analysis and classification algorithm. Flow cytometry data presents challenges for normalization due to the high dimensionality, the real-time processing, and the continuous flow of data during analysis. Current normalization techniques often require frequent running of control samples, which is both costly and time-consuming.

Aspects of the present disclosure address these and other technological challenges by introducing a novel approach to flow cytometry data normalization and analysis. These aspects include a real-time, adaptive normalization method that utilizes a queue of recent normal cases, which reduces or eliminates the need for separate control samples. This method accounts for instrument drift and inter-device variations, ensuring consistent results across different cytometers and over time. Additionally, aspects of the present disclosure incorporate a machine learning pipeline that combines Self-Organizing Maps (SOMs) for dimensionality reduction with classifiers, such as, for example, XGBoost. This approach allows for the integration of data from multiple cell populations, which results in capturing complex relationships in the data and providing more accurate and nuanced diagnostic predictions. By enabling real-time, adaptive analysis of flow cytometry data, aspects of the present disclosure improve the speed, consistency, and accuracy of flow cytometry data analysis.

Accordingly, the systems and methods provided herein use prior diagnostically normal cases (e.g., as determined by machine learning performed on the data of the machines, from text reports, or a combination thereof) to serve as controls for monitoring assay and instrument performance. After database initialization using N replicates of an initial case, the mean and CV of each case is averaged among the prior N normals run on a specific instrument (an average of normals) under the assumption that with sufficient normal cases, they are, as a whole, temporally undisguisable (reversion to the mean). Therefore, any changes to the mean and CV are the result of assay and instrumentation drift. With this data in hand, the systems and methods described herein adjust the mean and CV of each case using the most recent N normal cases using Z score normalization (e.g., mean of present case minus the mean of N prior normals, CV of present case divided by the CV of N prior normals). This results in data with less temporal variation.

In particular, while external controls could be run frequently to determine assay and instrument performance, it is logistically cumbersome and expensive to run controls at a high frequency. Examples described herein use clinical samples that are already being run to monitor for drifts in near real-time with the speed depending on how large N is, where N is the number of normal cases on a particular instrument, which spares the expense of additional labor and reagents that would otherwise be needed to help normalize data.

In other words, other solutions include using frequent external cellular or bead-based controls that add to cost and labor. Other solutions are also unable to perform data normalization in real-time and require specimens from both before and after any particular sample to determine normalization parameters. The examples described herein allow for on-the-fly normalization without the need for subsequent data.

For example, one apparatus described herein performs real-time data analytics and includes at least one electronic processor and at least one memory storing instructions executable by the at least one electronic processor. The at least one electronic processor is configured, through execution of the instructions, to obtain a sequence of cytometry data output by a cytometry instrument and normalize a first data point in the sequence of cytometry data using a set of normalization parameters determined based on a queue of cases belonging to a predetermined class. The at least one electronic processor is further configured to update the queue of cases belonging to the predetermined class with the normalized first data point in response to determining, using a machine learning model, the normalized first data point belongs to the predetermined class, and normalize a second data point in the sequence of cytometry data using an updated set of normalization parameters determined based on the updated queue of cases belonging to the predetermined class.

Examples described herein also provide a computer-implemented method for normalizing flow cytometry data. The method includes obtaining a sequence of cytometry data output by a cytometry instrument and normalizing, using a real-time data normalization component, a first data point in the sequence of cytometry data using a set of normalization parameters determined based on a queue of cases belonging to a predetermined class. The method further includes updating the queue of cases belonging to the predetermined class with the normalized first data point in response to determining, using a machine learning model, the normalized first data point belongs to the predetermined class, and normalizing, using the real-time data normalization component, a second data point in the sequence of cytometry data using an updated set of normalization parameters determined based on the updated queue of cases belonging to the predetermined class.

Yet another example provides a computer-implemented method for training a machine learning model. The method includes obtaining a sequence of normalized cytometry data comprising a plurality of tubes of data, generating a plurality of latent representations by generating a latent representation for each tube of data based on a normalized data point in the sequence of normalized cytometry data, wherein each of the plurality of latent representations is generated using a different Self-Organizing Map (SOM) model, and generating a concatenated representation by concatenating the plurality of latent representations. The method also includes generating, using the machine learning model, a prediction indicating whether the normalized data point belongs to a predetermined class by applying the machine learning model to the concatenated representation, calculating a prediction loss based on a difference between the prediction and ground-truth data, and updating parameters of the machine learning model based on the prediction loss.

Accordingly, examples described herein improve the accuracy of machine learning algorithms in flow cytometry by normalizing data over time and between flow cytometers so that the training and testing (inference) data are comparable (i.e., using an average of normals approach for real-time analysis). As noted above, other solutions use retrospective datasets where temporally past and future specimens (with respect to the specimen to be normalized) are required.

### BRIEF DESCRIPTION OF THE FIGURES

FIG. 1 schematically illustrates a data normalization system according to some examples.

FIG. 2 illustrates a machine learning pipeline performed by a machine learning model included in the data normalization system of FIG. 1 according to some examples.

FIG. 3 schematically illustrates a data analytics apparatus included the data normalization system of FIG. 1 according to some examples.

FIG. 4 is a flowchart illustrating a computer-implemented method for performing flow cytometry data analysis implemented via the data analytics apparatus of FIG. 3 according to some examples.

FIG. 5 is a flowchart illustrating a method for training a machine learning model used for flow cytometry analysis as part of the method of FIG. 4 according to some examples.

### DETAILED DESCRIPTION

One or more examples are described and illustrated in the following description and accompanying drawings. These examples are not limited to the specific details provided herein and may be modified in various ways. Furthermore, other examples may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some examples described herein may include one or more electronic processors configured to perform the described functionality by executing instructions stored in non-transitory, computer-readable medium (e.g., to perform the computer-implemented methods described herein). Similarly, examples described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer readable medium may include, for example, a hard disk, a CD-ROM, an optical storage device, a magnetic storage device, a ROM (Read Only Memory), a RAM (Random Access Memory), register memory, a processor cache, or any combination thereof.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, as noted above, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms, such as, for example, first and second, top and bottom, and the like may be used herein solely to distinguish one entity or action from another entity or action without necessarily requiring or implying any actual such relationship or order between such entities or actions.

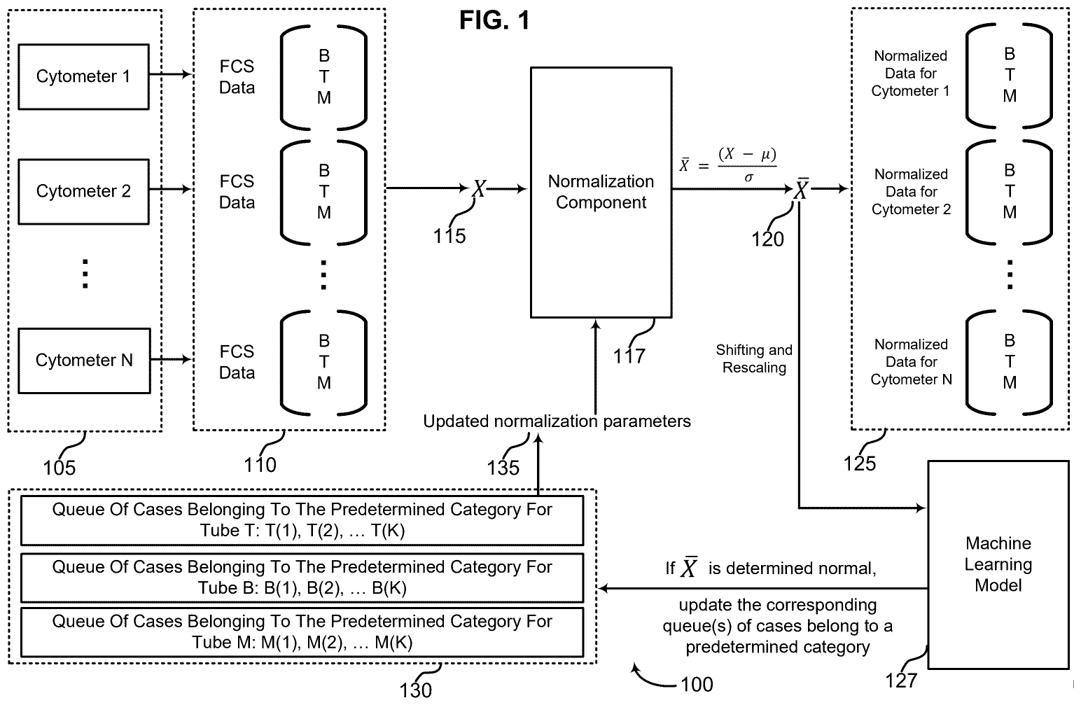

FIG. 1 schematically illustrates a data normalization system 100. The data normalization system 100 includes one or more cytometers 105, such as a plurality of cytometers 105 including cytometer 1, cytometer 2, and up to cytometer N (the cytometers are herein referred to collectively as a plurality of cytometers 105 or cytometers 105 and individually as cytometer 105). Each cytometer 105 generates Flow Cytometry Standard (FCS) data 110. In this example, the FCS data 110 comprises measurements for B (B lymphocytes), T (T lymphocytes), and M (Myeloid). However, examples of the present disclosure may not be limited thereto as the FCS data 110 may comprise measurements for panel types other than B, T, or M.

Each cytometer 105 generally refers to an analytical instrument used to analyze physical and chemical characteristics of individual cells or particles in a fluid stream. The cytometer 105 comprises components, such as, for example, (i) a fluidics system that transports and aligns cells in a single file through a laser beam, (ii) one or more lasers for illumination, (iii) a series of optical filters and mirrors to direct specific wavelengths of scattered and fluorescent light, (iv) multiple photodetectors, such as, for example, photomultiplier tubes to capture and quantify the light signals, and (v) a computer system for data acquisition and analysis. For example, as cells pass though the laser beam, the cytometer 105 (e.g., the computer system processing data captured via the photodetector(s)) measures forward scatter, side scatter, and fluorescence emissions from labeled cellular components. The cytometer 105 as described herein may be used to perform flow cytometry, mass cytometry, or imaging cytometer and may include various types of detectors. For example, in addition or in place of the photodetectors noted above, the cytometer 105 may include one or more Photomultiplier Tubes (PMTs), Avalanche Photodiodes (APDs), Complementary Metal Oxide Semiconductor (CMOs), Charged Coupled Devices (CCDs), or a combination thereof. In some examples, the functionality and methods described herein may be performed via the computer system of the cytometer 105, via one or more computer systems external to the cytometer 105, or a combination thereof.

Referring to FIG. 1, the FCS data 110 from each of the plurality of cytometers 105 undergoes a shift and rescale process for each of the B, T, and M panels or categories. This process results in data point 115, represented as X in FIG. 1, which is ready for normalization.

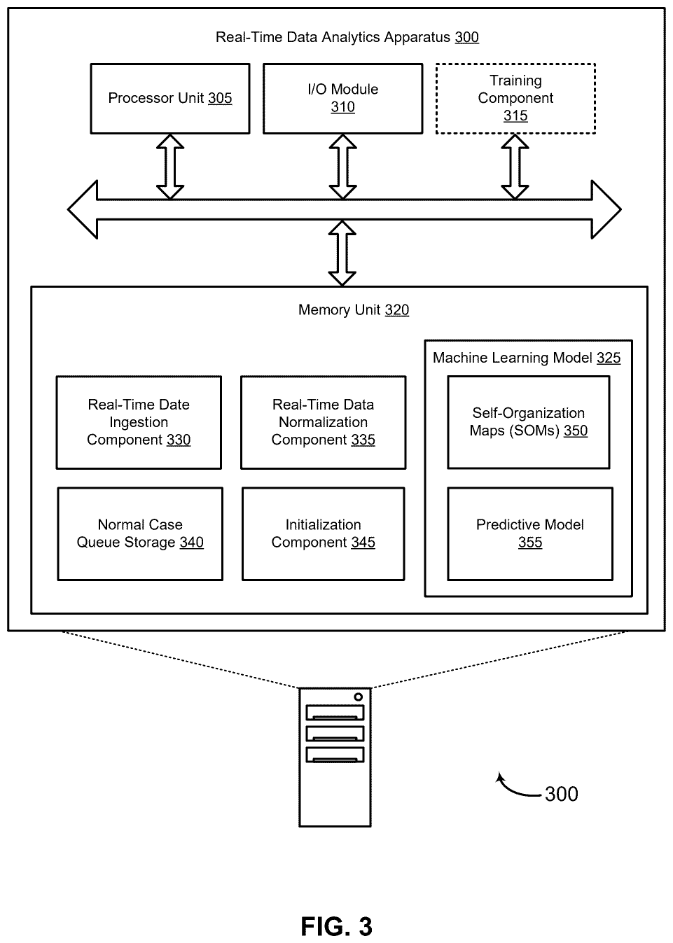

A normalization component 117 (e.g., implemented via one or more processor units 305 as described herein with respect to FIG. 3), processes the data point 115 (represented in FIG. 1 as X) using the formula

$$\overline{X} = \frac{( X - μ )}{σ} ,$$

where μ is the mean and σ is the standard deviation of a predetermined number of prior normal cases (e.g., the last 25 prior normal cases). This normalization transforms the data point 115 (X) into normalized data point 120 (represented in FIG. 1 as X̅).

The normalized data point 120 is included in the normalized streaming output 125, which provides a continuous stream of normalized flow cytometry data. Simultaneously, the normalized data point 120 is processed by a machine learning model 127 (e.g., implemented via one or more processor units 305 as described herein with respect to FIG. 3). For example, in response to the machine learning model 127 determining that the normalized data point 120 belongs to a predetermined class or category, for example, that the normalized data point 120 represents a normal sample or case, a queue(s) 130 is updated. In some examples, the queue(s) 130 maintains a predetermined of normal cases, such as, for example, the last (in time) K normal cases for each cytometer and each panel type (B, T, M), wherein K may be a natural number, such as, for example, 25.

The updated queue(s) 130 of normal cases is then used to determine updated normalization parameters 135. These updated normalization parameters 135 include a new mean (u) and standard deviation (o) calculated from the cases in the queue(s) 130 of normal cases. The updated normalization parameters 135 are then fed back into the normalization component 117. The feedback into the normalization component 117 creates an adaptive system where the normalization process continually adjusts to account for gradual changes in instrument performance or sample characteristics across the cytometers 105. In some examples, the normalized data shows near 0 mean and 1 standard deviation after Z-score normalization. The normalized streaming output 125 can then be further analyzed or used in downstream applications, maintaining consistency and comparability across samples and cytometers.

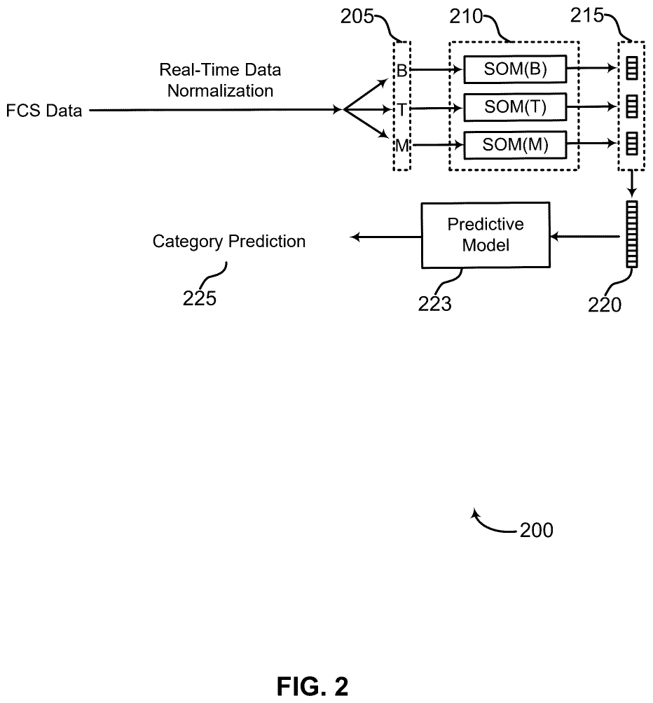

FIG. 2 illustrates a machine learning pipeline 200 performed by the machine learning model 127. The machine learning pipeline 200 may begin with the Flow Cytometry Standard (FCS) data 115 output by the plurality of cytometers 105 and normalized via the normalization component 117 (represented as data input 205 in FIG. 2). As noted above, the FCS data 205 may be categorized into a plurality of categories, such as, for example, categories B, T, and M. The categories represent different cell types or analysis conditions (panel types) in the flow cytometry data.

In some examples, each of the categories (B, T, and M) is processed through a corresponding Self-Organizing Map (SOM) 210. The SOMs 210 include SOM (B), SOM (T), and SOM (M), each specialized for its respective category. The SOMs 210 perform dimensionality reduction and feature extraction on the input data.

Each SOM 210 may include a neural network trained using an unsupervised machine learning technique that reduces complex, high-dimensional data into a low-dimensional (e.g., two-dimensional) grid, preserving the topological structure of the input data. The SOM 210 uses a competitive learning approach to cluster similar data points together on the grid (also referred to as a map). The neural network begins with a random set of weights for its nodes, representing points in the input space. For each input data point, the neural network finds the “Best Matching Unit” (BMU), which is the node whose weights are closest to the input data. The weights of the BMU are adjusted to become more like the input data. The weight of one or more nodes neighboring the BMU are also adjusted, but to a lesser extent than the adjustment to the BMU weights. This process is repeated for multiple input data points, gradually shaping the map so that similar data point cluster together on the map.

The output from each of the SOMs 210 forms latent representations 215. In this example, there are three latent representations 215, corresponding to the B, T, and M categories. Each of these latent representations 215 captures features and patterns of its respective category in a compressed form.

The latent representations 215 are then combined to form a concatenated representation 220. This concatenated representation 220 integrates information from all three categories, providing a comprehensive view of the sample that preserves the distinct characteristics of each cell type or analysis condition. The concatenated representation 220 is then passed through a predictive model 223, such as, for example, an XGBoost model. XGBoost, an advanced implementation of gradient boosted decision trees, processes this integrated data to generate an output. The system 100 uses the output to determine whether a particular data point (representing a case) from the normalized data stream represents a normal case (i.e., a predetermined category) for a particular panel and cytometer 105. In response to determining that a data point belongs to the predetermined category, the data point (case) is added to the appropriate queue 130, and the data stored in each queue is used to provide updated normalization parameters to the normalization component 117.

By utilizing specialized SOMs 210 for each category, creating integrated latent representations 215, and employing advanced machine learning techniques, such as, for example, XGBoost, the pipeline may capture complex patterns and relationships in the data, leading to more accurate and comprehensive predictions (e.g., a prediction whether a data point represents a normal case).

FIG. 3 schematically illustrates a real-time data analytics apparatus 300 included in the data normalization system 100, which may be used to implement the pipeline 200 as well as other functionality described herein as being performed via the data normalization system 100. The real-time data analytics apparatus 300 includes a processor unit 305 (such as, for example, one or more electronic processors), an input/output (I/O) module 310, an optional training component 315, and a memory unit 320. The memory unit 320 includes a real-time data ingestion component 330, a real-time data normalization component 335, a normal case queue storage 340, an initialization component 345, and a machine learning model 325 comprising one or more SOMs 350 and a predictive model 355. It should be understood that the apparatus 300 may include additional or fewer components and the components illustrated in FIG. 3 may be combined and distributed in various configurations. For example, the apparatus 300 may include more than one processor unit 305, more than one I/O module 310, more than one training component 315, more than one memory unit 320, or a combination thereof. Also, the functionality described herein as being performed via the components stored in the memory unit 320 may be combined and distributed in additional or fewer components, wherein a component may include a set of instructions (software) and/or data executable by the processor unit 305. It should also be understood that the functionality described herein as being performed via the apparatus 300 may be distributed among multiple devices.

As noted above, the processor unit 305 may include a microprocessor, an application-specific integrated circuit, or the like. The memory unit 320 includes non-transitory, computer-readable memory. The I/O module 310 includes one or more an input/output interfaces for communicating with components external to the apparatus 300 over one or more wired or wireless communication channels or networks.

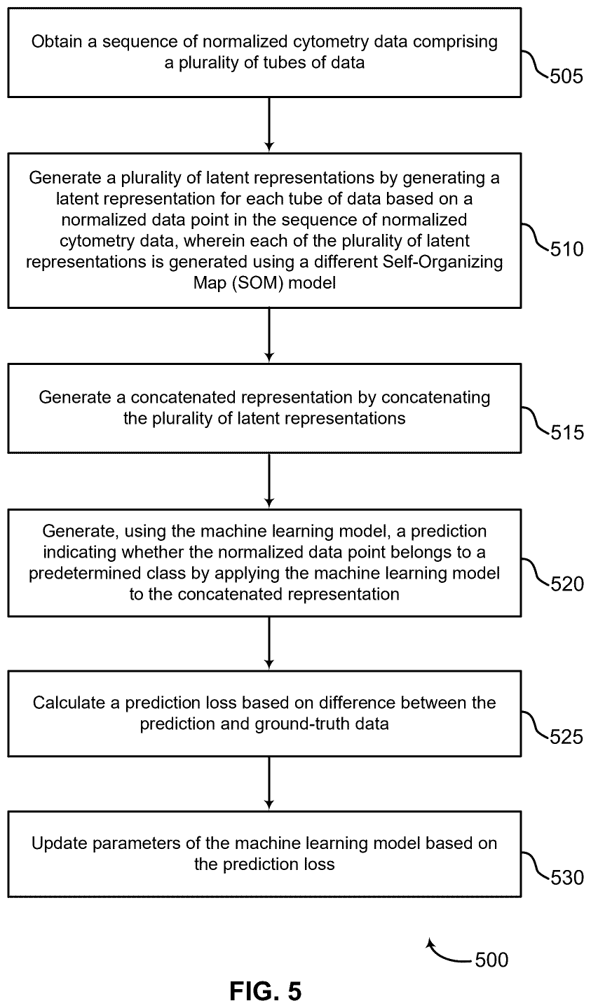

As described herein with respect to FIG. 5, the optional training component 315, which may be implemented as software stored in the memory unit 320 or stored in a separate memory unit of the apparatus 300, is configured to train the models and/or neural networks included in the machine learning model 325 (e.g., the SOMs 350 and/or the predictive model 355). In particular, the training component 315 may be configured to initialize the models/networks, iteratively input training data (which may be stored in the training component 315 or elsewhere) to the models/networks, and adjust internal parameters (e.g., weights and biases) of the models/networks until the models/networks is considered trained or accurate (e.g., until a loss function is minimized). The training component 315 is illustrated as being optional as, in some examples, the models/networks included in the machine learning model 325 may be initially trained by a separate apparatus as the apparatus 300 performing the real-time data analysis.

In some examples, the real-time ingestion component 330 continuously acquires and processes incoming flow cytometry data in real-time. For example, the real-time ingestion component 330 receives raw data streams from one or more flow cytometers 105 and converts raw data streams into a standardized format, such as, for example, FCS files 110. In some examples, the real-time ingestion component 330 organizes and prepares data from multiple channels, representing different cell types, such as, for example, B cells, T cells, and myeloid cells, for subsequent processing. As used herein, “real-time” refers to a system or process that responds and updates immediately or with minimal delay, typically within milliseconds or microseconds. This immediacy allows information to be accessed and acted upon almost instantaneously. As used herein, “real-time” also includes “near real-time,” which implies a slight but acceptable delay in data processing and response, such as within seconds or a few minutes. Accordingly, real-time can be contrasted with “batch processing” or “offline processing,” wherein data is collected, stored, and processed at a later time.

In some examples, the real-time data normalization component 335 (which may include the normalization component 117 described above with respect to FIG. 1) normalizes the incoming cytometry data (FCS data 110) in real-time. For example, the real-time data normalization component 335 applies normalization parameters derived from the queue(s) 130 of normal cases to each channel of the data independently. The normalization process may involve techniques, such as, for example, Z-score normalization, where raw measurements are transformed using the formula (X−μ)/σ. The real-time data normalization component 335 adaptively updates μ and σ to account for instrument drift. In this example, the normalization remains accurate over time and across different cytometers.

In some examples, the normal case queue storage 340 maintains separate queues (e.g., the queues 130 described above with respect to FIG. 1) of normal cases for each channel and each cytometer. In some examples, the normal case queue storage 340 stores a predetermined number (e.g., 25) of the most recent normal cases (which may be set by a user), continuously updating by removing the oldest case and adding the newest normal case as determined by the machine learning model 325 (e.g., the machine learning model 127). In these examples, the normal case queue storage 340 provides the basis for calculating and updating normalization parameters used by the real-time data normalization component 335, allowing the system 100 to adapt to gradual changes in instrument performance or sample characteristics.

In some examples, the initialization component 345 sets up the system 100 before normal operation begins. For example, the initialization component 345 may be configured to populate the initial queue(s) 130 of normal cases stored in the normal case queue storage 340 using prior diagnostically normal cases. In some examples, the initialization component 345 also creates arrays representing normal distributions for each channel across the initial queue(s) 130 of normal cases. These initial values provide a starting point for the normalization parameters used by the real-time data normalization component 335, ensuring the system 100 can begin operating effectively from the outset.

In some examples, the machine learning model 325 (e.g., the machine learning model 127) comprises the SOMs 350 (e.g., the SOMs 210 described above with respect to FIG. 2) and the predictive model 355 (e.g., the predictive model 223 described above with respect to FIG. 2). As described above, the SOMs 350 include a set of neural network models, one for each channel of the cytometry data. Each SOM 350 generates a latent representation of its corresponding channel, effectively reducing the dimensionality of the data while preserving its essential features. The SOMs 350 can be pre-trained on large datasets and fine-tuned during operation. The predictive model 355 processes the concatenated latent representations from the SOMs 350 to determine whether a data point belongs to the pre-determined class or category, such as whether the data point is normal. In some examples, the predictive model 355 may use one or more predictive techniques, such as, for example, XGBoost to generate predictions. In some examples, the output from the predictive model 355 is a binary classification (normal/abnormal). In some examples, the predictions from the machine learning model 325 are used to continuously refine the normalization process as the predictions control what data points are added to the queue(s) 130, and wherein the data stored in the queue(s) 130 generate the normalization parameters used by the real-time data normalization component 335.

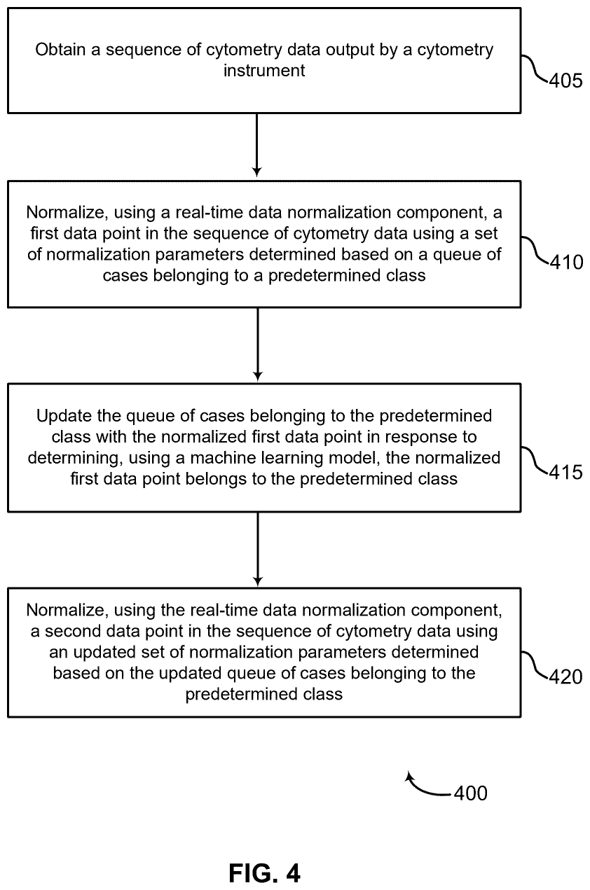

FIG. 4 is a flowchart illustrating a computer-implemented method 400 for performing flow cytometry data analysis. The method 400 may be performed via a computer system, such as the real-time data analytics apparatus 300 in FIG. 3 to implement the functionality of the system 100 described herein.

At operation 405, the method 400 includes obtaining (via the computer system) a sequence of cytometry data output by a cytometry instrument 105. In some examples, the sequence of cytometry data may be converted from real-time raw data. The sequence of cytometry data may include measurements from one or more patient samples. In some examples, this data is multidimensional, containing information for multiple cell types and parameters measured by the flow cytometer 105. In these examples, the sequence of cytometry data may include data from one or more cytometers 105, with each cytometer 105 measuring multiple types of cells (e.g., B cells, T cells, and myeloid cells) and other cellular characteristics.

In some examples, the cytometers 105 measure the same cell types and characteristics, with each cytometer 105 having a distinct bias or slight variations in sensitivity. As further discussed herein, the normalization method 400 provided herein can be adaptive across these different cytometers 105. For example, by maintaining separate queues 130 of normal cases and normalization parameters for each cytometer 105, the system 100 can account for and adapt to the specific biases of individual instruments.

In some examples, at operation 405, the cytometry data is structured into multiple channels (e.g., as the FCS data 110), with each channel representing a subset of data for a specific cell type or measurement category. This multi-channel approach, combined with device-specific normalization, may allow for more precise and targeted normalization that accounts for both the diversity of cell types and the individual characteristics of each cytometer.

At operation 410, the computer system normalizes, using the real-time data normalization component 335, a first data point in the sequence of cytometry data using a set of normalization parameters determined based on the queue 130 of cases belonging to a predetermined class. In some examples, this normalization process is performed independently for each channel of the cytometry data, accounting for the characteristics of different cell populations and measurement types.

For example, for each channel, the computer system applies normalization parameters (such as, for example, mean or median and a coefficient of variation (CV)) derived from a corresponding queue 130 of normal cases. The normalization may involve Z-score normalization, where raw measurements are transformed using the formula (X−μ)/σ, with μ and σ being adaptively updated to account for instrument drift specific to each channel. This channel-specific normalization ensures that variations in instrument performance or sensitivity across different cell types are appropriately addressed.

At operation 415, the computer system updates the queue 103 of cases belonging to the predetermined class with the normalized first data point (i.e., adds the normalized first data point to the queue) in response to determining, using the machine learning model 325, that the normalized first data point belongs to the predetermined class. As described herein, the machine learning model 325 may employ a multi-stage approach, first generating latent representations for each channel using separate Self-Organizing Map (SOM) models 350, then concatenating these representations, and finally classifying the concatenated representation as normal or abnormal using the predictive model 355.

In these examples, in response to the normalized data point being classified as belonging to the pre-determined class, the computer system updates the queue 130 of normal cases. This update may involves removing the oldest case from the queue 130 and adding the normalized data point to the queue 130 as the newest case. In some examples, this process is performed for each channel's queue independently, maintaining a rolling window of recent normal cases for each cell type or measurement category.

At operation 420, the computer system normalizes, using the real-time data normalization component 335, a second data point in the sequence of cytometry data using an updated set of normalization parameters determined based on the updated queue 130 of cases belonging to the predetermined class. In some examples, the computer system then proceeds to normalize the next data point in the sequence, utilizing the updated normalization parameters derived from the newly updated queue 130 of normal cases. In these examples, this process mirrors the normalization of the first data point but benefits from the most recent updates to the normal case queue 130 and resulting normalization parameters. By using these updated parameters, the normalization process adapts to gradual changes in instrument performance or sample characteristics over time. As demonstrated in some examples provided herein, this adaptive approach allows for more accurate and consistent normalization across the sequence of cytometry data, improving the reliability of subsequent analyses and comparisons between samples.

FIG. 5 is a flowchart illustrating an example method 500 for training a machine learning model (e.g., the predictive model 355) used for the flow cytometry analysis performed as part of the method 400. The method 500 may be performed via a computer system, such as, for example, the real-time data analytics apparatus 300 illustrated in FIG. 3. However, in other configurations, the method 500 may be performed by an apparatus separate from the apparatus 300, wherein the trained models/networks are transferred and stored on the apparatus 300 for inference use. The method 500 for training the machine learning model may be implemented by a training component, such as, for example, the optional training component 315 illustrated in FIG. 3.

At operation 505, the computer system obtains a sequence of normalized cytometry data comprising a plurality of tubes of data.

The sequence of normalized cytometry data is used as the input for training the machine learning model (i.e., the predictive model 355). In some examples, operation 505 may involve receiving a stream of raw data from flow cytometers (or from a database of stored data) and converting it into a series of Flow Cytometry Standard (FCS) files. The FCS format allows for standardization of data across different instruments and analysis platforms. In some examples, the FCS format has multiple channels, and each channel corresponds to a different cell type or measurement category (e.g., B cells, T cells, myeloid cells).

At operation 510, the computer system generates a plurality of latent representations by generating a latent representation for each tube of data based on a normalized data point in the sequence of normalized cytometry data, wherein each of the plurality of latent representations is generated using a different Self-Organizing Map (SOM) model 210.

In some examples, separate SOM models 210 are employed for each channel. As descried herein, SOMs refer to a type of artificial neural network that produce a low-dimensional representation of the input space, reducing the dimensionality of the data while preserving its topological structure.

For example, each SOM model 210 is tailored to the corresponding channel, allowing the SOM model 210 to capture the characteristics and patterns of that particular cell type or measurement category. In some implementations, these SOM models 210 may be pretrained on a large dataset of cytometry data, which can help in capturing general features of cytometry data before fine-tuning on the specific dataset at hand.

At operation 515, the computer system generates a concatenated representation by concatenating the plurality of latent representations generated by the plurality of SOM models 210 (as multiple channels). This concatenated representation combines information from the multiple cell types and measurement categories, providing a holistic view of the data points. For example, the concatenation allows the subsequent machine learning model (i.e., the predictive model 355) to consider interactions and relationships between different cell populations and measurements.

At operation 520, the computer system generates, using the machine learning model, a prediction indicating whether the normalized data point belongs to a predetermined class by applying the machine learning model (i.e., the predictive model 355) to the concatenated representation. For example, the concatenated representation is fed into a machine learning model to generate a prediction about whether the sample is normal. For example, this model may be a complex ensemble model, such as, for example, a XGBoost model.

In some examples, the prediction output can take various forms. For example, the prediction output may be a binary classification (normal/abnormal). However, the prediction output may also include a predicted probability distribution (including a likelihood that the normalized data point belongs to a predicted class), which may allow for more nuanced predictions, capturing different degrees or types of abnormalities.

At operation 525, the computer system calculates a prediction loss based on difference between the prediction and ground-truth data (included as part of the training data obtained at operation 505). In some examples, the ground-truth data includes prior clinically validated results, ensuring that the model 355 is learning to make predictions that align with expert clinical assessments. In some examples, the choice of loss function depends on the nature of the prediction. For example, for binary classifications, cross-entropy loss may be used as a loss function. For example, for probability distributions, KL divergence may be used as a loss function.

At operation 530, the computer system updates parameters of the machine learning model (i.e., the predictive model 355) based on the prediction loss. For example, the computer system uses the calculated loss to update the parameters of the machine learning model (i.e., the predictive model 355), which may be done through backpropagation and gradient descent or one of its variants. In some examples where the SOM models 210 are being trained along with the predictive model 355, the SOM models' parameters are also updated at operation 530. In some alternative examples, when pretrained SOMs 210 are used, this update operation may only apply to the parameters of the predictive model 355.

In some examples, the training portion of the method 500 including operations 505, 510, 515, 520, 525, and 530 is repeated for multiple data points in the sequence. This repetition gradually improves the predictive model's ability to accurately determine whether a data point belongs to the pre-determined class. Once trained, the trained machine learning model is used as part of the pipeline 200 described herein for processing real-time data.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Various features, advantages, and examples are set forth in the following claims.

What is claimed is:

1. An apparatus for real-time data analytics comprising:
at least one electronic processor; and
at least one memory storing instructions executable by the at least one electronic processor, the at least one electronic processor configured, through execution of the instructions, to:
obtain a sequence of cytometry data output by a cytometry instrument;
normalize a first data point in the sequence of cytometry data using a set of normalization parameters determined based on a queue of cases belonging to a predetermined class;
update the queue of cases belonging to the predetermined class with the normalized first data point in response to determining, using a machine learning model, the normalized first data point belongs to the predetermined class; and
normalize a second data point in the sequence of cytometry data using an updated set of normalization parameters determined based on the updated queue of cases belonging to the predetermined class.

2. The apparatus of claim 1, wherein the sequence of cytometry data includes a plurality of tubes of data, each tube of data representing a subset of data corresponding to a different one of a plurality of data categories, and
wherein the at least one electronic processor is further configured to normalize each tube of data using corresponding normalization parameters based on a corresponding queue of cases belonging to the predetermined class.

3. The apparatus of claim 2, wherein the plurality of different data categories includes one or more cell types, and wherein the set of normalization parameters include at least one selected from a group consisting of a mean, a medium, and a coefficient of variation (CV).

4. The apparatus of claim 1, wherein the at least one electronic processor is configured to determine, using the machine learning model, the normalized first data point belongs to the predetermined class by:
generating a plurality of latent representations by generating a latent representation for each tube of data of a plurality of tubes of data in the normalized first data point, wherein each of the plurality of latent representations is generated using a different Self-Organizing Map (SOM) model;
generating a concatenated representation by concatenating the plurality of latent representations; and
determining the concatenated representation belonging to the predetermined class using the machine learning model.

5. The apparatus of claim 1, wherein the at least one electronic processor is further configured to:
remove an oldest case in the queue of cases; and
add the normalized first data point to the queue of cases as a newest case.

6. The apparatus of claim 1, wherein the at least one electronic processor is further configured to initialize the queue of cases belonging to the predetermined class with a plurality of cases diagnostically determined to belong to the predetermined class, and wherein the set of normalization parameters is initialized by creating an array representing a normal distribution for each tube of data across the queue of cases belonging to the predetermined class.

7. A computer-implemented method for normalizing flow cytometry data comprising:
obtaining a sequence of cytometry data output by a cytometry instrument;
normalizing, using a real-time data normalization component, a first data point in the sequence of cytometry data using a set of normalization parameters determined based on a queue of cases belonging to a predetermined class;
updating the queue of cases belonging to the predetermined class with the normalized first data point in response to determining, using a machine learning model, the normalized first data point belongs to the predetermined class; and
normalizing, using the real-time data normalization component, a second data point in the sequence of cytometry data using an updated set of normalization parameters determined based on the updated queue of cases belonging to the predetermined class.

8. The computer-implemented method of claim 7, wherein the set of normalization parameters include at least one selected from a group consisting of a mean, medium, and a coefficient of variation (CV).

9. The computer-implemented method of claim 7, wherein the sequence of cytometry data includes a plurality of tubes of data, each tube of data representing a subset of data corresponding to a different one of a plurality of data categories, and wherein normalizing the first data point includes normalizing each tube of data using corresponding normalization parameters based on a corresponding queue of cases belonging to the predetermined class.

10. The computer-implemented method of claim 9, wherein the plurality of data categories includes one or more cell types.

11. The computer-implemented method of claim 9, wherein normalizing the first data point comprises:
applying Z-score normalization X̅=(X−μ)/σ to each tube of data, wherein μ and σ are adaptively updated to account for instrument drift corresponding to each tube of data.

12. The computer-implemented method of claim 7, wherein determining, using the machine learned model, the normalized first data point belongs to the predetermined class includes:
generating a plurality of latent representations by generating a latent representation for each tube of data of a plurality of tubes of data in the normalized first data point, wherein each of the plurality of latent representations is generated using a different Self-Organizing Map (SOM) model;
generating a concatenated representation by concatenating the plurality of latent representations; and
determining the concatenated representation belongs to the predetermined class using the machine learning model.

13. The computer-implemented method of claim 7, wherein updating the queue of cases belonging to the predetermined class comprises:
removing an oldest case in the queue of cases; and
adding the normalized first data point to the queue of cases as a newest case.

14. The method of claim 7, wherein the queue of cases belonging to the predetermined class is initialized with a plurality of cases diagnostically determined to belong to the predetermined class, and wherein the set of normalization parameters is initialized by creating an array representing a normal distribution for each tube of data across the queue of cases.

15. A computer-implemented method for training a machine learning model comprising:
obtaining a sequence of normalized cytometry data comprising a plurality of tubes of data;
generating a plurality of latent representations by generating a latent representation for each tube of data based on a normalized data point in the sequence of normalized cytometry data, wherein each of the plurality of latent representations is generated using a different Self-Organizing Map (SOM) model;
generating a concatenated representation by concatenating the plurality of latent representations;
generating, using the machine learning model, a prediction indicating whether the normalized data point belongs to a predetermined class by applying the machine learning model to the concatenated representation;
calculating a prediction loss based on a difference between the prediction and ground-truth data; and
updating parameters of the machine learning model based on the prediction loss.

16. The computer-implemented method of claim 15, wherein obtaining the sequence of normalized cytometry data further comprises:
receiving a stream of raw data output by a cytometry instrument;
converting the stream of raw data to a series of Flow Cytometry Standard (FCS) files to form a sequence of cytometry data; and
normalizing the sequence of cytometry data to form the sequence of normalized cytometry data.

17. The method of claim 15, wherein the machine learning model includes an XGBoost model.

18. The method of claim 15, wherein a SOM model is pretrained.

19. The method of claim 15, wherein the ground-truth data includes clinically validated prior data.

20. The method of claim 15, wherein the prediction is a probability distribution indicating a likelihood that the normalized data point belongs to the predetermined class.
